(19) United States
(12) Patent Application Publication
(10) Pub. No.: US 2007/0157686 A1
(43) Pub. Date: Jul. 12, 2007

(54) LOCK

(75) Inventors: Yifeng Chen, Hong Kong (CN); Hay To Chu, Hong Kong (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Victory Dragon International Industrial Company Limited, Hong Kong (CN)

(21) Appl. No.: 11/613,139

(22) Filed: Dec. 19, 2006

(30) Foreign Application Priority Data
Dec. 19, 2005 (CN) 200520146399.0
Dec. 28, 2005 (CN) 200520006623.6

(51) Int. Cl. E05B 39/04

(52) U.S. Cl. 70/436

(57) ABSTRACT

A mechanical counting device for a lock, comprising; a bottom support (1); a counting gear (2); a counting rotation lever (4); a button (5); a stop lever (6) to stop the counting gear (2) returning back to the original position when the button (5) is activated; and a carry-over pinion (8); wherein activating the button (5) causes; driving the counting rotation lever (4) to move and cause the counting gear (2) to rotate, resetting a counting gear spindle (12) back to zero, propping the carry-over pinion (8) against and driving the counting gear (2) to perform carry-over, and propping an elastic plate (7) against a carry-over pinion spindle (9) to move within a hole of the bottom support (1).

### CROSS-REFERENCE TO RELATED APPLICATIONS

The present patent application claims priority from Chinese Patent Application No. 200520146399.0 filed on Dec. 19, 2005 and Chinese Patent Application No. 200520006623.6 filed on Dec. 28, 2005.

1. Field of the Invention

The invention concerns a mechanical counting device for a lock, and an improved lock.

2. Background of the Invention

Traditional counting devices for locks typically have a large structure with complex components. Also, miscounting occurs sometimes.

### SUMMARY OF THE INVENTION

In a first preferred aspect, there is provided a mechanical counting device for a lock, comprising:
a bottom support;
a counting gear;
a counting rotation lever;
a button;
a stop lever to stop the counting gear returning back to the original position when the button is activated; and
a carry-over pinion;
wherein activating the button causes:
driving the counting rotation lever to move and cause the counting gear to rotate,
resetting a counting gear spindle back to zero,
propping the carryover pinion against and driving the counting gear to perform carry-over, and
propping an elastic plate against a carry-over pinion spindle to move within a hole of the bottom support.

The mechanical counting device has a very small size with advanced structure and technology and precise counting. The counted numbers may be as high as six bits.

In a second aspect, there is provided a lock comprising:
a lock body;
a lock beam; and
a mechanical counting device as described;
wherein the mechanical counting device is installed into the lock body.

Advantageously, a reliable and safe lock is provided.

### BRIEF DESCRIPTION OF THE DRAWINGS

An example of the invention will now be described with reference to the accompanying drawings, in which:

FIG. 1 is a front perspective view of a mechanical counting device in accordance with a preferred embodiment of the present invention;

FIG. 2 is a rear perspective view of the device of FIG. 1;

FIG. 3 is a perspective view of the device of FIG. 1 with a cover;

FIG. 4 is a bottom plan view of the device of FIG. 1;

FIG. 5 is a right side plan of the device of FIG. 1;

FIG. 6 is a front plan view of the device of FIG. 1;

FIG. 7 is a left side plan view of the device of FIG. 1;

FIG. 8 is a sectional side view of the device of FIG. 1;

FIG. 9 is a top plan view of the device of FIG. 1;

FIG. 10 is a perspective view of a lock using the mechanical counting device of FIG. 1 in accordance with a preferred embodiment of the present invention; and

FIG. 11 is a sectional view of the lock, of FIG. 10.

### The parts list is:

1 bottom support
2 counting gear
3 stop spindle
4 counting rotation lever
5 button
6 stop lever
7 elastic plate
8 carry-over pinion
9 carry-over pinion spindle
10 lens
11 top support
12 counting gear spindle
13 counting gear stopper
14 spring
21 lock core
22 lock beam
23 spring
24 lock body
25 mechanical counting device

### DETAILED DESCRIPTION OF THE DRAWINGS

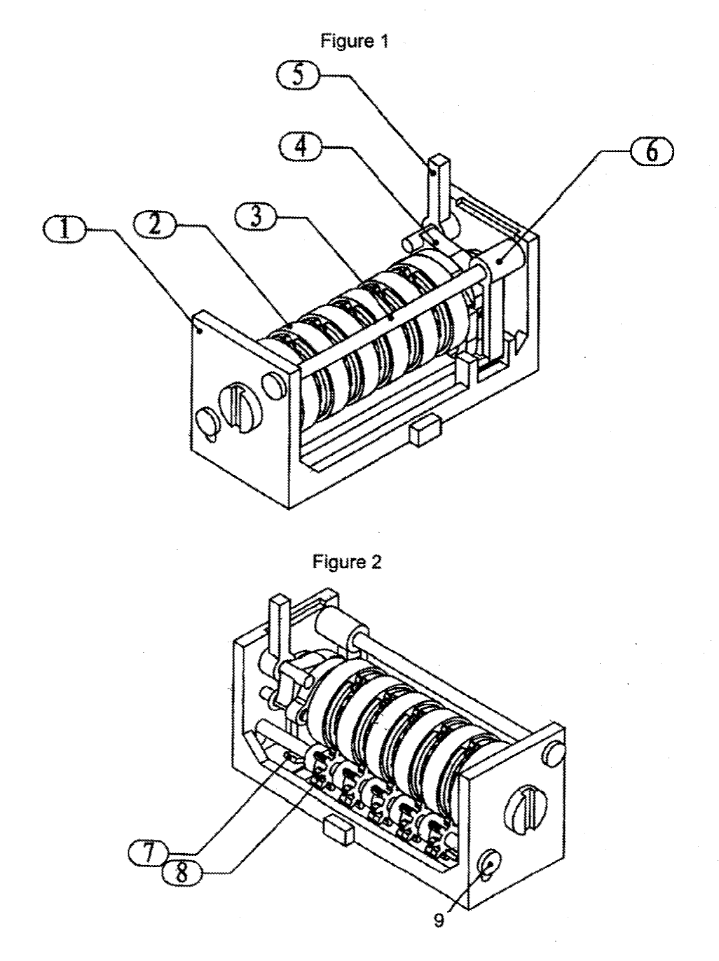

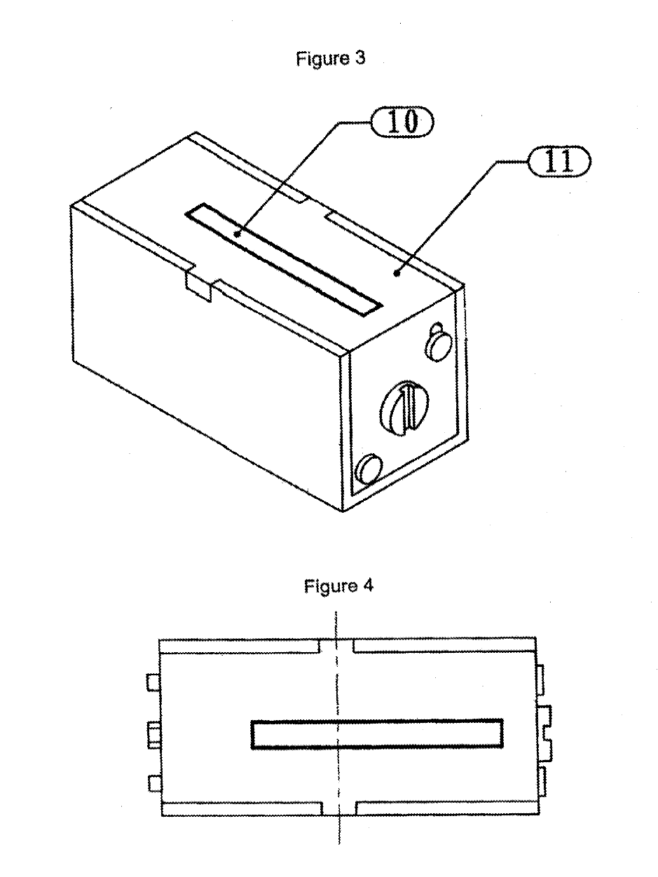

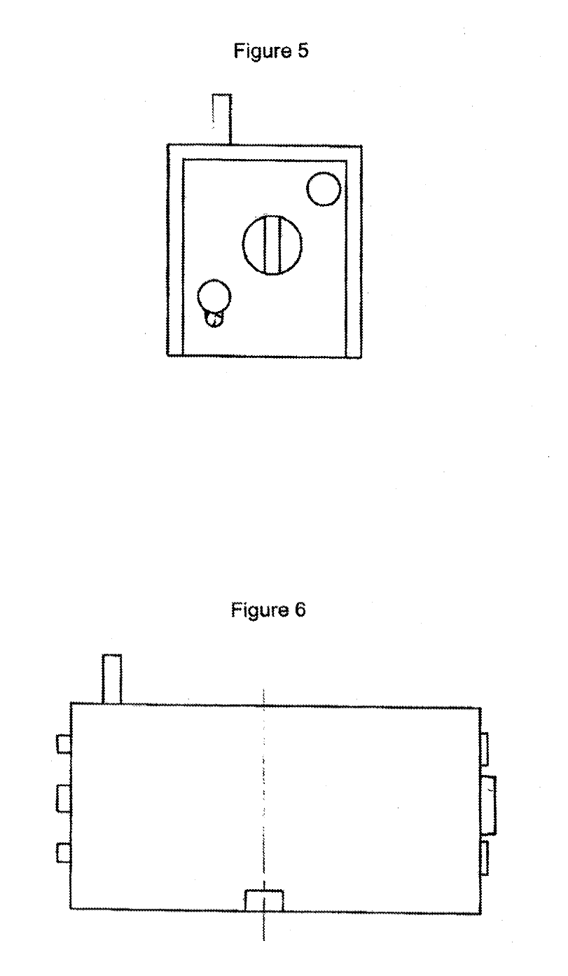

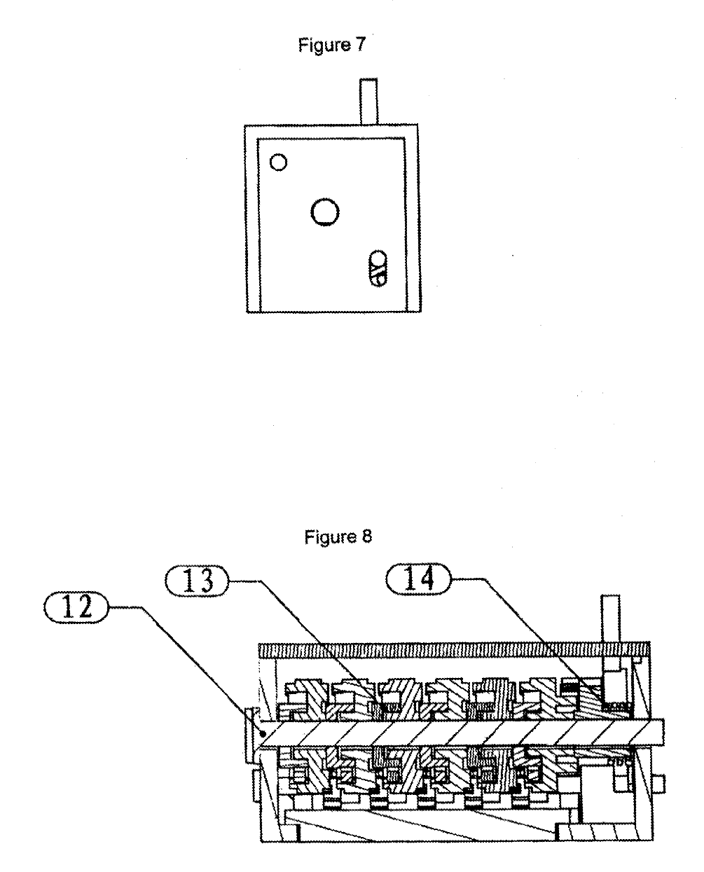

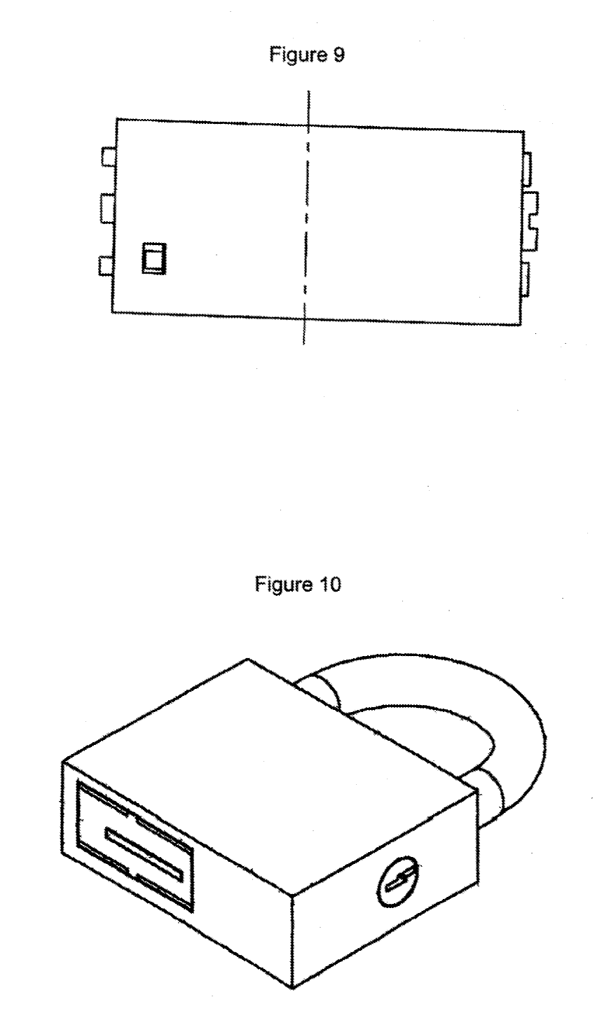

Referring to FIGS. 1 to 9, a mechanical counting device for a lock is provided. The mechanical counting device generally comprises: a bottom support 1, a counting gear 2, a counting rotation lever 4, a button 5, a stop lever 6 to stop the counting gear 2 returning back to the original position when the button 5 is activated, and a carry-over pinion 8. When the button 5 is activated it causes: driving of the counting rotation lever 4 to move and cause the counting gear 2 to rotate. A counting gear spindle 12 is reset back to zero. The carry-over pinion 8 is propped against and driving the counting gear 2 to perform carry-over. An elastic plate 7 is propped against a carry-over pinion spindle 9 to move within a hole of the bottom support 1.

The counting gear spindle 12, stop lever 3, carry-over pinion spindle 9 and elastic plate 7 are mounted onto the bottom support 1; the lens 10 is mounted onto the top support 11. The stop lever 6 is mounted onto the stop spindle 3. The carry-over pinion 8 is mounted onto the carry-over pinion spindle 9. The carry-over pinion spindle 9 is floated up-downwardly by the force of elastic plate 7 (the rectangular holes are located on the ends of the bottom support 1). The counting gear 2, counting gear stopper 13 and counting rotation lever 4 are mounted onto the counting gear spindle 12; the spring 14 and button 5 are mounted onto the counting rotation lever 4.

When the button 4 is activated, for example, by pressing it down, the counting rotation lever 4 is driven to move in a circular motion. The counting rotation lever 4 drives the adjacent counting gear 2 to move at a certain angle and the numbers on the counting gear 2 shift. After the button 5 is deactivated, the counting gear rotating lever 4 returns back to the original position by the resilient force of spring 14. The counting gear 2 does not return back to its original position due to the stop lever 6. After each counting gear 2 rotates nine times, the carry-over pinion 8 drives the next counting gear to rotate one time and to carry-over the number. The displayed numbers are seen via the lens 10.

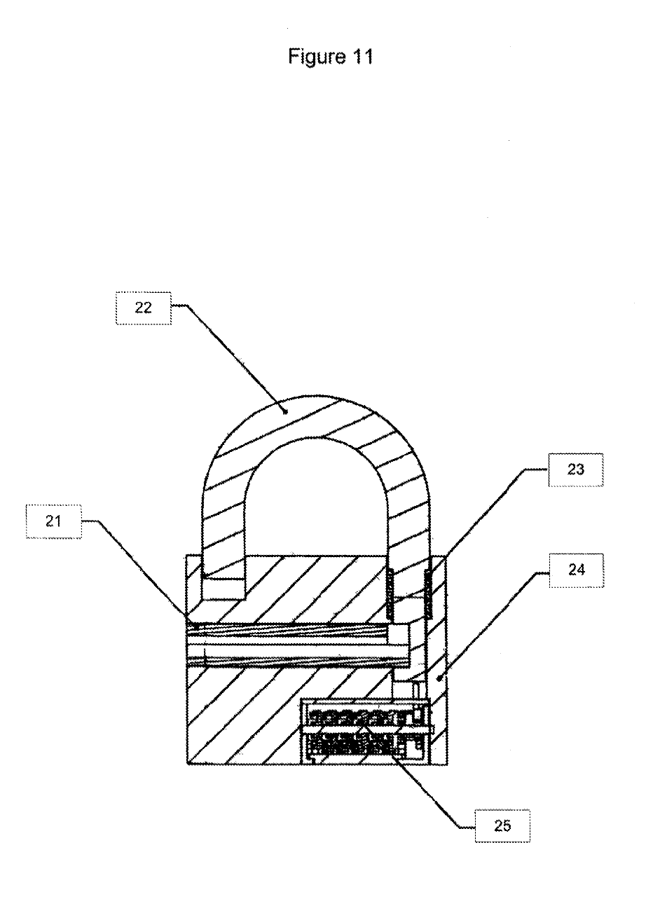

Referring to FIGS. 10 and 11, a key is inserted into a lock core 21 and the key is turned. The spring 23 of a lock beam 22 projects the lock beam 22 out and completes the lock-opening. The key is not able to be pulled out from lock core 21 in this state. After the lock beam 22 is pressed down, the lock beam 22 presses down the button on the mechanical counting device 25. The mechanical counting device 25 is similar to the one illustrated in FIG. 1, The digits vary through the movement in the mechanical counting device 25. The counted digits would be changed in their increasing order and the lock-closing process is completed. The key may be pulled out from lock core 21 in this state. After the lock-closing is completed, the digits in the lock-closing process may be memorized to act for the purpose of evidence.

The lock includes the lock body, lock beam 22, lock core 21 mechanical counting device 25 and other parts. The lock is combined with the mechanical counting device 25. Each time the key is inserted into the lock core 21 and is turned, the spring 23 within the lock beam 22 ejects up the lock beam 22 to open the lock. The key is fixed in the lock core 21 at this time and the lock-opening procedure is thus completed. If the lock beam 22 is pressed down to close the lock, the mechanical counting device 25 turns around by the bottom pressing down of the lock beam 22 to complete a single digit recording. The key may be pulled out from lock core 21 at this time to complete the lock closing procedure and start the next counting.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A mechanical counting device for a lock, comprising:
a bottom support;
a counting gear;
a counting rotation lever;
a button;
a stop lever to stop the counting gear returning back to the original position when the button is activated; and
a carry-over pinion;
wherein activating the button causes:
driving the counting rotation lever to move and cause the counting gear to rotate,
resetting a counting gear spindle back to zero,
propping the cary-over pinion against and driving the counting gear to perform carry-over, and
propping an elastic plate against a carry-over pinion spindle to move within a hole of the bottom support.

2. A lock comprising:
a lock body;
a lock beam; and
a mechanical counting device according to claim 1;
wherein the mechanical counting device is installed into the lock body.
